(19) United States
(12) Patent Application Publication
(10) Pub. No.: US 2010/0162161 A1
(43) Pub. Date: Jun. 24, 2010

(54) SMOOTH PIXEL-BASED SCROLLING IN A USER INTERFACE CONTROL

(75) Inventors: Yifung Lin, Bellevue, WA (US); Scott Morrison, Redmond, WA (US); Brian Christopher Braeckel, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/342,088

(22) Filed: Dec. 23, 2008

(51) Int. Cl. G06F 3/048

(52) U.S. Cl. 715/786

(57) ABSTRACT

Described is a technology in which a user interface element (a control, e.g., a datagrid) provides smoother scrolling by computing and updating a row height estimate. For example, the row height estimate along with the total number of rows may be used to configure a scrollbar. A control outputs visible rows according to user scrolling interaction based on a current row index and current pixel values corresponding to that current row index. The estimate is obtained based upon the current row index and the current pixel value for the row index. Whenever a row index is encountered that is larger than any previously-encountered row index, the row height estimate is updated, e.g., to reconfigure the scrollbar. Also described is outputting partially visible rows based on a number of pixels available in a display area below a last fully visible row, and/or above a first fully visible row.

### BACKGROUND

In contemporary computing, a datagrid is a graphical user interface element (e.g., a control) that outputs visible rows of data. Datagrids that handle a large number of rows have difficulty scrolling vertically when the rows have variable heights. This is because in general, a datagrid only creates the subset of rows that are currently being displayed. The datagrid knows how many rows there are in total in the data, but does not know what the combined height of all of the rows is, because the data may have a million or more rows of differing heights while the data grid only works with (creates and measures) twenty of them at a time, for example. In addition, a datagrid cannot store too much information about the rows it has previously created, because doing so would negatively affect performance, e.g., storing information on each row would limit the number of rows the datagrid could support.

Without knowing the combined height of all of the rows, a datagrid cannot configure the vertical scrollbar properly, which leads to unintuitive or “jumpy” scrolling behavior. More particularly, datagrids handle this situation by doing row based scrolling where every row represents the same amount of scrollbar space, regardless of its actual height. This produces an unexpected experience because a small row takes up the same amount of scrolling space as a tall row, causing the jumpy behavior. Also under this constraint, the user would not be able to scroll halfway down a row.

As another drawback, datagrids either show an entire row, or none of the row. Not being able to scroll to see a partial row, or simply not seeing any part of a row that exists when there is the ability on the display to show part of the row is generally undesirable to computer users.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which smooth scrolling in a control (e.g., datagrid) is facilitated by computing and updating a row height estimate based on row indexes and corresponding pixel values. A control outputs a subset of rows of a set of data based on a current row index and current pixel values corresponding to that current row index. The control manages a scrolling mechanism (e.g., configures a scrollbar) based on an estimated height of the rows relative to a total number of rows. The estimate is obtained based upon the current row index and the current pixel value for the row index. Whenever (e.g., because of user scrolling) a row index is encountered that is larger than or equal to any previously-encountered row index, the row height estimate is updated so as to change management of the scrolling mechanism, e.g., reconfigure the scrollbar.

In one aspect, partially visible rows may be output based on a number of pixels available in a display area below the last full row, and/or above the first full row.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components for a datagrid control that dynamically estimates row heights and can show partial rows.

FIG. 2 is a representation showing information that explains how rows are shown and row heights dynamically re-estimated as row height information becomes known.

FIG. 3 is a flow diagram showing example steps taken to dynamically estimate row heights using pixel values.

FIG. 4 shows an illustrative example of a computing environment into which various aspects of the present invention may be incorporated.

### DETAILED DESCRIPTION

Various aspects of the technology described herein are generally directed towards a user interface control that computes a dynamic row height estimate of the combined height of all of the rows of data and thereby produces smoother scrolling. The row height estimate is performed using an efficient calculation for good performance, without consuming additional memory per row, which is updated to become more accurate as the control comes across more rows. In one implementation, pixel-based scrolling is enabled whereby rows can be partially scrolled in/out of view.

While a datagrid control is used as an example of a user interface element that implements the estimation computations and/or pixel-based scrolling, it should be understood that any of the examples described herein are non-limiting examples. For example, a list-type (listbox, listview) control may perform similar computations for large lists, and column width estimation may likewise benefit from the technology described herein. Indeed, as used herein, the term “row” and “column” are equivalent (with vertical replaced by horizontal as appropriate, and so forth). As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and user interface elements in general.

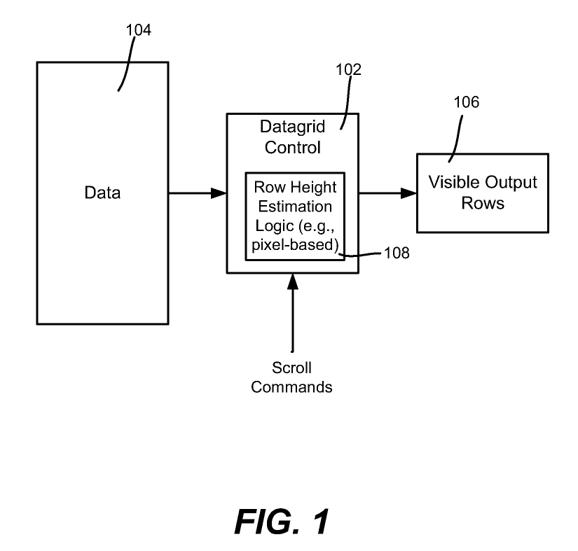

FIG. 1 shows various aspects related to row height estimation and/or pixel-based scrolling in a user interface element exemplified by the datagrid control 102. In general, the datagrid control 102 creates, measures and shows a portion of (possibly large) amounts of row data 104 as visible output rows 106.

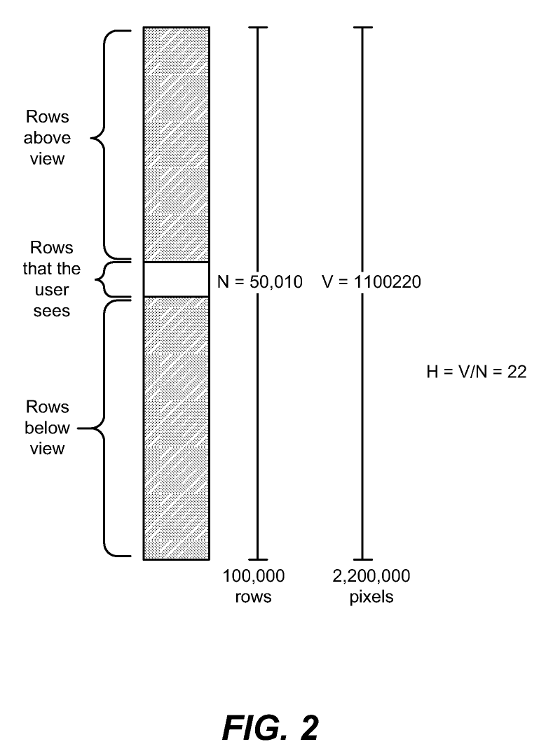

The rows that are currently visible depend on where the user has scrolled by interaction with the control 102 via scroll commands (e.g., via keyboard or pointing device input). FIG. 2 is a representation of how scrolling provides a logical view into the data.

As described herein, the datagrid control 102 includes row height estimation logic 108. In general, the height estimation logic performs a computation based on what is known about the row heights from previous scrolling. This information is used to reconfigure the vertical scrollbar so as to provide a more consistent scrolling experience.

In one implementation, a row height estimate is computed based on

H=V/N

where H is the row height estimate based on N, which equals the row number (index) currently scrolled to and V, which equals the vertical distance that was scrolled to get to row N. Thus, in the example of FIG. 2, the current row scrolled to is N=50010 and the vertical distance is 1100220 (in pixels), whereby the estimated row height is V/N=22 pixels per row. This row height estimate H may be used to compute the combined height of the rows beyond what the datagrid is currently displaying, thereby facilitating smooth scrolling.

The value of H is dynamic and is updated for a number of reasons, including that individual row heights can change and/or the datagrid wide row height can change. In general, the more that a user scrolls, the more accurate the estimate becomes.

The estimate update is performed whenever the datagrid has more information about a row and corresponding height information. For example, this may occur when the user has scrolled further down the datagrid, or if the user scrolls slower than previously scrolled. A reason that slower scrolling produces more information is because when the user scrolls quickly, for performance reasons the datagrid skips rows by using the row height estimate instead of measuring each individual row that was scrolled.

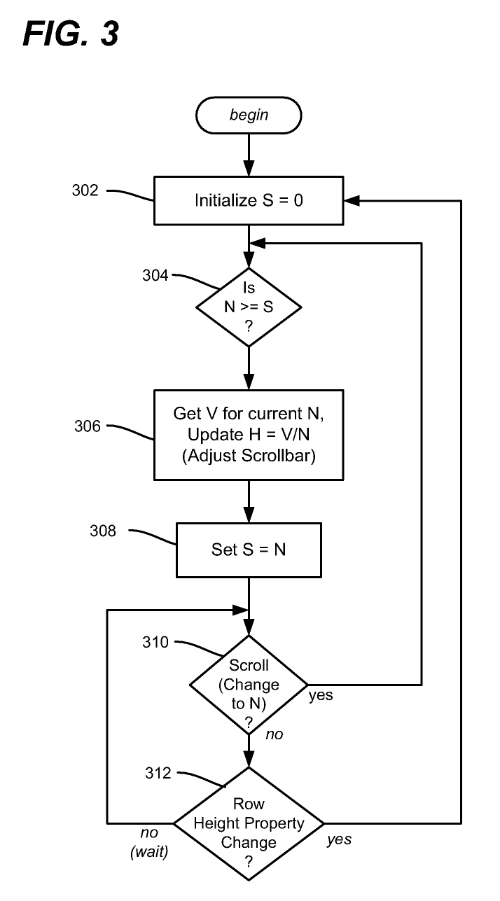

In one implementation, the estimate H is updated whenever a row that is greater than or equal to the largest row index previously encountered is reached. FIG. 3 shows example logic, beginning at step 302 where a variable S that tracks the largest row index that has been encountered is initialized to zero.

Then, whenever the current row index is larger than or equal to an index value previously encountered, that is, N>=S as evaluated by step 306, H is updated at step 306 based on the corresponding current N and V information. Scrolling interaction may be modified at this time (e.g., whenever H changes or changes sufficiently), e.g., the scrollbar size, how much the rows move when scrolling interaction occurs, and so forth. S is then increased to N's value at step 308. Note that H is recomputed even when N equals S because more information may be available since the last time S was set to N.

Step 310 represents reevaluating N versus S whenever N changes, and performing the update when appropriate, as described above. Note that when a property that significantly affects row heights changes, the process resets the value of S because it is likely that H is no longer accurate. Step 312 represents detecting and branching back to step 302 upon such a property change. Note that while steps 310 and 312 are shown in a loop for purposes of explanation, it is understood that the wait may be until an event occurs.

Further, it can be readily appreciated that a more complex system may be used to determine whether to update the estimate. As can be readily appreciated, however, updating H based on encountering a larger-indexed row is reasonably accurate, while being efficient and using minimal storage.

With respect to pixel scrolling to show partial views, the datagrid control 102 tracks the pixels, and thus can determine how much of the lowest and/or highest visible rows to display. For example, instead of computing fifteen rows because that is how many full rows fit on the screen, the datagrid control 102 creates and measures an above row and/or a below row, and shows the portion of each that fits within the available screen above and/or below the full rows.

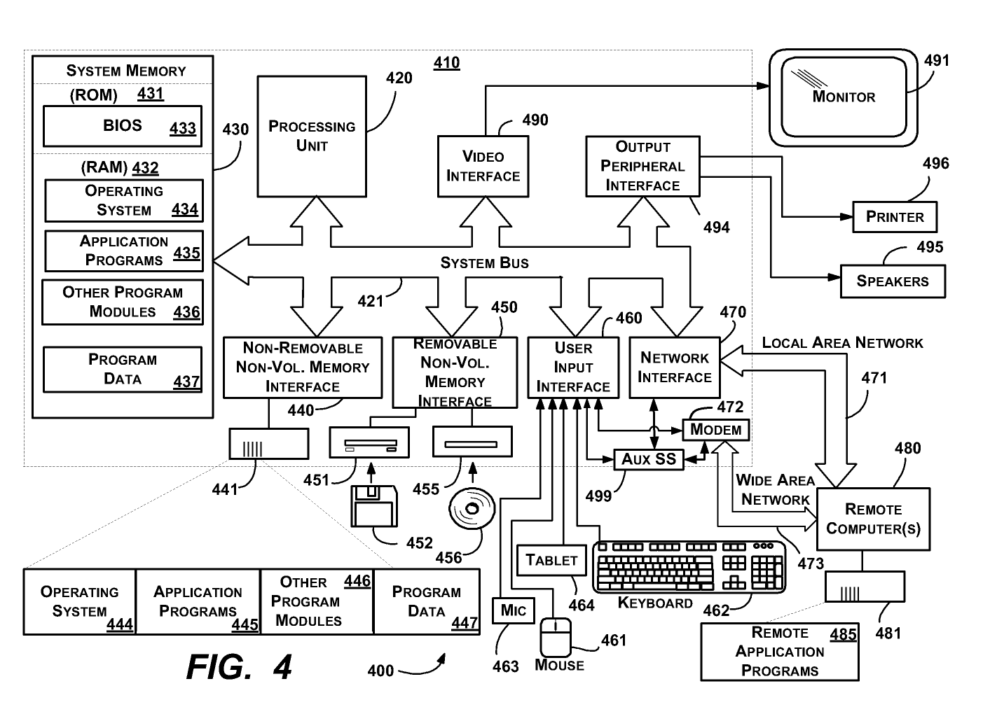

Exemplary Operating Environment FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, displaying representations of rows of data via a control, computing an estimated row height based upon a current row index and current pixel value corresponding to the row index, and using the estimated row height to manage vertical scrolling-related user interaction.

2. The method of claim 1 wherein computing the estimated row height comprises dividing the current pixel value by the current row index.

3. The method of claim 1 further comprising tracking the largest row index that has been previously encountered, and re-computing the estimated row height when the current row index exceeds that largest row index.

4. The method of claim 3 wherein tracking the largest row index that has been previously encountered comprises setting the largest row index to the current row index when the current row index exceeded that largest row index.

5. The method of claim 3 further comprising resetting the largest row index upon detecting a row-related property change.

6. The method of claim 1 wherein using the estimated row height to manage vertical scrolling-related user interaction comprises reconfiguring a vertical scrollbar to scroll rows based upon the estimated row height and a total number of rows of the data.

7. The method of claim 1 wherein the control comprises a datagrid control, or a list-type control.

8. The method of claim 1 further comprising, outputting a partial row below a last full row based on a number of pixels available in a display area below the last full row.

9. The method of claim 1 further comprising, outputting a partial row above a first full row based on a number of pixels available in a display area above the first full row.

10. In a computing environment, a system comprising, a control that displays representations of rows of data and provides a scrolling mechanism for scrolling through the rows, the control including logic that computes an estimated row height based upon a current row index and current pixel value corresponding to the current row index, the control managing vertical scrolling via interaction with the scrolling mechanism based upon the estimated row height.

11. The system of claim 10 wherein the estimated row height is obtained by dividing the current pixel value by the current row index.

12. The system of claim 10 wherein the control manages a variable that tracks the largest row index that has been previously encountered, and re-computes the estimated row height when the current row index exceeds that largest row index.

13. The system of claim 12 wherein the control sets the variable to the to the current row index when the current row index exceeded that largest row index.

14. The system of claim 12 wherein the control resets the variable to an initial state upon detecting a row-related property change.

15. The system of claim 10 wherein the control comprises a datagrid control, or a list-type control.

16. The system of claim 10 wherein the control outputs a partially visible row below a last full row based on a number of pixels available in a display area below the last full row, or outputs a partial row above a first full row based on a number of pixels available in a display area above the first full row, or both outputs a partially visible row below a last full row based on a number of pixels available in a display area below the last full row and outputs a partial row above a first full row based on a number of pixels available in a display area above the first full row.

17. One or more computer-readable media having computer-executable instructions, which when executed perform steps, comprising:
outputting a subset of rows of a set of data based on a current row index and current pixel values corresponding to that current row index; and
determining whether a current row index equals or exceeds a variable value that tracks a largest row index previously encountered, and if so, updating a row height estimate based on the current row index and the current pixel values corresponding to that current row index, adjusting a scrolling mechanism based on the row height estimate, and setting the variable value to the current row index.

18. The one or more computer-readable media of claim 17 wherein updating a row height comprises dividing the current pixel value by the current row index.

19. The one or more computer-readable media of claim 17 having further computer-executable instructions comprising, resetting the variable to an initialization value upon detecting a row-related property change.

20. The one or more computer-readable media of claim 17 having further computer-executable instructions comprising, outputting a partially visible row below a last full row based on a number of pixels available in a display area below the last full row, or outputting a partial row above a first full row based on a number of pixels available in a display area above the first full row, or both outputting a partially visible row below a last full row based on a number of pixels available in a display area below the last full row and outputting a partial row above a first full row based on a number of pixels available in a display area above the first full row.
